(19) United States
(12) Patent Application Publication
(10) Pub. No.: US 2012/0301360 A1
(43) Pub. Date: Nov. 29, 2012

(54) NANOSTRUCTURED AEROGEL-THERMOELECTRIC DEVICE, MAKING AND USING THE SAME

(75) Inventors: Mitchell W. MEINHOLD, Medford, CA (US); Andrew A. GUZELIAN, Belmont, MA (US); Robert A. ROUFAIL, Marlborough, MA (US); Brent M. SEGAL, Woburn, MA (US); James M. SPATCHER, North Kingstown, RI (US); Aaron G. SELL, Salem, AL (US); Eric C. HOLIHAN, Boston, MA (US); Jonathan A. NICHOLS, North Andover, MA (US)

(73) Assignee: LOCKHEED MARTIN CORPORATION, Bethesda, MD (US)

(21) Appl. No.: 13/475,902

(22) Filed: May 18, 2012

Related U.S. Application Data
(60) Provisional application No. 61/490,558, filed on May 26, 2011.

(51) Int. Cl. G01N 1/40; F25B 21/02; G01N 21/75; G01N 29/00; B01D 9/04; G01N 27/62; B82Y 15/00

(52) U.S. Cl. 422/68.1; 62/123; 62/3.7; 436/173; 34/284; 436/164; 436/177; 422/82.01; 422/82.05; 977/700; 977/742; 977/752; 977/750; 977/762; 977/774; 977/773; 977/902; 977/745

(57) ABSTRACT

Devices used in conjunction with detecting analytes and methods of their manufacture are disclosed. A pre-concentrator device includes a thermoelectric material and an aerogel which includes a nanostructured material disposed on, and in thermal communication with, the thermoelectric material. Such a pre-concentrator is part of a detection system including a sensor. The detection system is used in a method for detecting analytes.

### STATEMENT OF RELATED APPLICATIONS

This application claims priority to U.S. Provisional Application No. 61/490,558 filed on May 26, 2011, which is hereby incorporated by reference in its entirety.

### BACKGROUND

The present invention relates to devices used in conjunction with detecting analytes and methods of their manufacture.

Analyte detection in micro-sensor systems may suffer from low signal-to-noise ratio when analytes are present in very low concentrations. In some configurations, where low analyte concentrations are routinely encountered, a pre-concentrator upstream from the sensor may be employed to provide a means of concentrating the sample. The pre-concentrator may contain an adsorbent material to which the analyte substance adheres. The pre-concentrator may then be heated, for example, to cause the analyte to be desorbed at an increased concentration. Thus, by desorbing the captured analyte in a much smaller volume than its initial volume, one can effectively increase sensitivity and reduce the limits of detection.

Current pre-concentrator devices, however, may be limited in their capacity to adsorb analytes. Other pre-concentrators may provide insufficient flexibility in design for modification to adsorb specialized analytes. Still further, existing pre-concentrators may lack the means for imparting selectivity for choosing one analyte over another.

### SUMMARY OF THE INVENTION

The present invention relates to devices used in conjunction with detecting analytes and methods of their manufacture.

In some aspects, embodiments disclosed herein relate to a pre-concentrator device comprising a thermoelectric material and an aerogel comprising a nanostructured material disposed on and in thermal communication with the thermoelectric material.

In other aspects, embodiments disclosed herein relate to a method of manufacturing a pre-concentrator device comprising an aerogel, the method comprising disposing a solution of a nanostructured material in a solvent on a surface of a thermoelectric material, cooling the solution of the nanostructured material with the aid of the thermoelectric material until the solvent freezes to provide an aerogel precursor, and subliming the aerogel precursor to provide the pre-concentrator device comprising the aerogel.

In still further aspects, embodiments disclosed herein relate to a detection system comprising a pre-concentrator device, the pre-concentrator device comprising a thermoelectric material and an aerogel comprising a nanostructured material in thermal communication with the thermoelectric material, and the system further comprising a sensor, wherein the sensor is configured to receive one or more analytes from the pre-concentrator device.

In yet still further aspects, embodiments disclosed herein relate to a method of detecting an analyte comprising providing a detection system comprising a pre-concentrator device, the pre-concentrator device comprising a thermoelectric material and an aerogel comprising a nanostructured material in thermal communication with the thermoelectric material and the system further comprising a sensor, wherein the sensor is configured to receive the analyte from the pre-concentrator device, the method further comprising exposing a sample comprising the analyte in an eluant to the pre-concentrator device while cooling the pre-concentrator device to provide a bolus of concentrated analyte, and releasing the bolus of concentrated analyte for delivery to the sensor.

The features and advantages of the present invention will be readily apparent to those skilled in the art upon a reading of the description of the various embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIG. 1 shows an illustrative photograph of a carbon nanotube aerogel;

FIG. 2A-2C show illustrative scanning electron microscope (SEM) images of a carbon nanotube aerogel formed by freeze drop deposition on a Si wafer surface at various magnifications; and

FIG. 3 shows a schematic of an illustrative carbon nanotube-based sensor platform.

### DETAILED DESCRIPTION

Embodiments disclosed herein relate to devices used in conjunction with detecting analytes and methods of their manufacture. In some embodiments, pre-concentrator devices of the invention employ aerogels comprising nanostructured materials disposed on a theremoelectric material. Detection systems may employ such a pre-concentrator to enhance sensitivity of detection.

Among the many advantages, the present invention provides pre-concentrator devices with adsorbent materials having exceptionally large surface areas for adsorption of analytes via the synergistic combination of (1) nanostructured materials and (2) an aerogel configuration for these nanostructured materials. On their own, nanostructured materials provide high surface area, however, their inclusion in an aerogel type structure allows these materials to realize the full potential of this surface area by creating targeted densities and porosities in hierarchical structures that can maximize the exposed surface area of the nanostructured material compared to, for example, a mat-like membrane structure of a nanomaterial.

In particular embodiments, the nanostructured materials may comprise high aspect ratio nanostructured materials such as carbon nanotubes, nanorods, nanofibers and the like; such high aspect ratio nanomaterials naturally facilitate the formation of an aerogel structure. As used herein, the term “aerogel” refers to a structure that is derived by replacing the solvent component of a frozen aerogel precursor (formed by cooling of a solution of the nanostructured material) with a gas, without appreciable shrinkage of the network created in the solid state. Solvent removal may be accomplished, for example, by sublimation. In some embodiments, the aerogel structure may be further enhanced by the use of solvents, such as water, that expand upon freezing.

Advantageously, the manufacture and use of pre-concentrator devices of the invention are streamlined in that the thermoelectric material facilitates both the device manufacture and its downstream operation in detection systems employing the pre-concentrator device. That is, the thermoelectric material, which may be, for example, a Peltier cooling device, can be used both in the preparation of the aerogel material and, subsequently, the nascent pre-concentrator device employed in a detection system where the same thermoelectric material serves to cycle through cooling and heating an analyte-laden sample to provide the concentrated analyte bolus. The detection systems of the invention can be configured for continuous flow of analyte in an eluant or for batch processing.

More generally, there are several advantages of using pre-concentrators of the invention in sensing applications, and particularly pre-concentrators containing carbon nanotubes, and more particularly, pre-concentrators containing carbon nanotube aerogels. First, a pre-concentrator improves device sensitivity by concentrating an analyte over time and releasing it to the sensor over a short time interval. Second, molecular discrimination for individual volatile organic compound (VOC) entities can be realized, particularly if variable temperature control is implemented. Third, time-resolved data can be obtained if the analyte on the pre-concentrator can be released quickly and subsequent time-of-flight (migration speed differentiation) is used to discriminate across analytes of various types. Finally, specificity across varying molecular binding affinities can be realized if the surface of the pre-concentrator is treated or functionalized with an appropriate chemical functionality. In this regard, carbon nanotube functionalization, in particular, is well established in the art and provides the springboard to access analyte specific pre-concentrator devices.

This present disclosure provides a versatile method of creating micron and millimeter-scale nanostructured aerogels, and carbon nanotube aerogel films, in particular, for this application and others. The thickness, density, functionalization and incorporation of additional nanomaterials into these films can be controlled such that the pre-concentrator element can be optimized for a particular application. In addition, the processes described herein for forming carbon nanotube aerogels are readily amenable to scaleup and manufacturing. Moreover, many of the principles as applied to carbon nanotubes as a the nanostructured material carries over to other nanostructure materials such as nanofiber, nanorods, and the like.

With respect to carbon nanotubes, in particular, they are advantageously highly thermally conductive, have a high surface area (especially in aerogel form), and can be readily functionalized with a variety of chemistries, they provide a good platform for use as a pre-concentration element, especially when combined with a miniature thermoelectric element (i.e., a heater). As described above, it is possible to chemically functionalize the carbon nanotubes of the aerogel or to incorporate other constituents throughout a carbon nanotube matrix prior to forming an aerogel.

In some embodiments, palladium (Pd) nanoparticles, for example, can be dispersed in a carbon nanotube aerogel. Carbon nanotube aerogels containing Pd nanoparticles can be used for H₂ sensing in a non-limiting embodiment. In some embodiments, a biomolecule may be immobilized for the detection of other biomolecules or airborne biohazards. In some embodiments, the biomolecule may be a peptide, protein, or enzyme. In some embodiments, the biomolecule may be DNA or RNA. In some embodiments, the biomolecule may be a carbohydrate such as glucose, galactose, rhamnose, N-acetylglucosamine, sialic acid, any of which may take on its naturally occurring or non-naturally occurring sterochemical configuration. In some embodiments, functionalization of the nanostructured material in the aerogel may provide a charged surface. In some embodiments, functionalization of the nanostructured material may be configured to bolster any substantially reversible targeted ligand-receptor pairing. Numerous other molecular recognition motifs will be apparent to the skilled artisan, any of which may be accessible via functionalizing the nanostructured materials of the aerogel.

In some embodiments, methods for forming a carbon nanotube aerogel can produce a carbon nanotube aerogel film that has a much higher surface area than those that have conventionally been produced in the art. According to the methods described herein, droplets of a carbon nanotube containing fluid may be frozen in place and converted into an aerogel at the millimeter and micro size scale. In some embodiments, the carbon nanotube aerogels produced as described herein can be substantially free of metal catalysts, which significantly distinguishes the present carbon nanotube aerogels from those produced, for example, by a CVD approach.

In some embodiments, the present invention provides a pre-concentrator device comprising a thermoelectric material and an aerogel comprising a nanostructured material disposed on and in thermal communication with the thermoelectric material. The pre-concentrator device can employ any number of nanostrucutred materials to provide an aerogel structures. As used herein, the term “nanostructured materials” refers to a material having at least one dimension that is measured on a nanometer scale. Such a scale may range from about 0.1 nm up to about 500 nm. A nanostructured material can be larger, for example, from about 500 nm to about 1,000 nm, however, the material selected should still exhibit nanoscale properties that provide benefits over bulk properties, especially large effective surface areas. In some embodiments, the nanostructured material has one dimension that is measured on the nanometer scale. In some embodiments, the nanostructured material has at least two dimensions that are measured on the nanometer scale. In some embodiments, the nanostructured material can be measured on the nanometer scale in three dimensions, although it may still display a relatively high aspect ratio across at least two dimensions to facilitate aerogel formation.

In some embodiments, devices of the invention employ nanostructured materials comprising carbon nanotubes. In some aspects, embodiments disclosed herein provide carbon nanotube aerogels and various methods for production thereof. The methods for production of the carbon nanotube aerogels can include depositing droplets of a solution or suspension of carbon nanotubes on a cold surface and then subliming the solvent to leave behind a carbon nanotube aerogel film.

In some embodiments, devices of the invention employ carbon nanotubes comprising at least one selected from the group consisting of single-walled carbon nanotubes (SWNTs), double-walled carbon nanotubes (DWNTs), and multi-walled carbon nanotubes (MWNTs). In some such embodiments, the carbon nanotubes can be functionalized. In some embodiments, the carbon nanotubes can be predominantly single-wall carbon nanotubes, double-wall carbon nanotubes, or multi-wall carbon nanotubes. In some embodiments, combinations of SWNTs, DWNTs and MWNts may be employed in the aerogel. As used herein, the term “carbon nanotube” refers generally to single-wall carbon nanotubes, double-wall carbon nanotubes, and multi-wall carbon nanotubes, any of which can be used singularly or in combination with one another in the present embodiments.

The types of carbon nanotubes in the present embodiments can generally vary without limitation. The carbon nanotubes can be metallic, semimetallic, or semiconducting depending on their chirality. An established system of nomenclature for designating carbon nanotube chirality is recognized by one of ordinary skill in the art and is distinguished by a double index (n,m), where n and m are integers that describe the cut and wrapping of hexagonal graphite when formed into a tubular structure. In addition to chirality, a carbon nanotube's diameter also influences its electrical conductivity and the related property of thermal conductivity. In the synthesis of carbon nanotubes, a carbon nanotube's diameter can be controlled by using catalytic nanoparticles of a given size. Typically, a carbon nanotube's diameter is approximately that of the catalytic nanoparticle that catalyzes its formation. Therefore, the carbon nanotubes' properties can be controlled in one respect by adjusting the size of the catalytic nanoparticles used for carbon nanotube growth, for example. By way of non-limiting example, catalytic nanoparticles having a diameter of about 1 nm can be used to prepare single-wall carbon nanotubes. Larger catalytic nanoparticles can be used to prepare predominantly multi-wall carbon nanotubes, which have larger diameters because of their multiple nanotube layers, or mixtures of single-wall and multi-wall carbon nanotubes. Multi-wall carbon nanotubes typically have more complex electrical and thermal conductivity profiles than do single-wall carbon nanotubes due to interwall reactions that can occur between the individual nanotube layers and redistribute current non-uniformly. By contrast, there is no change in the electrical and thermal conductivity profiles across different portions of a single-wall carbon nanotube.

The carbon nanotubes used in the present embodiments can be made by any known technique, for example, arc methods, laser oven, chemical vapor deposition, flame synthesis, and high pressure carbon monoxide (HiPCO). The carbon nanotubes be in a variety of forms, e.g., soot, powder, fibers, “bucky papers,” etc. carbon nanotubes can be in their raw, as-produced form, or they can be purified by a purification technique, if desired. Furthermore, mixtures of raw and purified carbon nanotubes may be used. In some embodiments, the carbon nanotubes can be in a substantially debundled state. That is, the carbon nanotubes are substantially present as individual carbon nanotubes. In alternative embodiments, however, the carbon nanotubes can be present as ropes or bundles of carbon nanotubes.

In some embodiments, the carbon nanotubes can be capped with a fullerene-like structure. Stated another way, the carbon nanotubes have closed ends in such embodiments. However, in other embodiments, the carbon nanotubes can remain open-ended. In some embodiments, closed carbon nanotube ends can be opened through treatment with an appropriate oxidizing agent (e.g., HNO₃/H₂SO₄). In some embodiments, the carbon nanotubes can encapsulate other materials.

In various embodiments, the carbon nanotubes can be functionalized. Functionalized carbon nanotubes can be obtained by the chemical modification of any of the above-described carbon nanotube types. Such modifications can involve the carbon nanotube ends, sidewalls, or both. Chemical modification can include, but is not limited to, covalent bonding, ionic bonding, chemisorption, intercalation, surfactant interactions, polymer wrapping, cutting, solvation, and combinations thereof.

As used herein, the term “functionalized,” when used in reference to carbon nanotubes, refers to carbon nanotubes that have been subjected to a post-carbon nanotube synthesis reaction that results in the presence of a covalently-linked organic functional group. Examples of such functional groups include, without limitation, carboxylic acids, amines, alcohols, amides, esters, halogens, such as fluorine, bromine, iodine, chlorine, sulfides, sulfates, and the like.

In some embodiments, carbon nanotubes can be functionalized by oxidative etching to provide carboxylic acid functional group handles. Such handles may occur at defects along the carbon nanotubes walls and/or at the end caps. The carboxylic acid group may be attached to a molecular recognition molecule directly or via a linker. The carboxylic acid functional group also serves as a handle as a ligand for metal atoms and/or metal ions.

Carboxylic acid functional group which can be obtained by oxidative procedures known in the art, for example, by treatment with concentrated nitric acid. In some embodiments, the carbon nanotubes are functionalized with fluorine. In some embodiments, the carbon nanotubes are functionalized with hydrogen. In some embodiments, the carbon nanotubes are functionalized with carboxylic acid groups and are subsequently fluorinated. In some embodiments, the carboxylic acid groups of a functionalized carbon nanotube are further functionalized as an ester or amide. In some embodiments, the carboxylic acid is a metal salt, including for example, a sodium or potassium salt. In some embodiments, the carboxylic acid groups of a functionalized carbon nanotube are reacted with an amino acid or peptide. In some embodiments, the carboxylic acid groups of a functionalized carbon nanotube are reacted with a polyol. In some embodiments, the carboxylic acid groups of a functionalized carbon nanotube are reacted with a polyethylene glycol (PEG) moiety.

In some embodiments, carbon nanotubes can be employed with a length in a range from about 0.5 microns to about 5 microns. In some embodiments, the carbon nanotubes can have a length in a range from about 2 microns to about 3 microns, including all fractions in between. In some embodiments, longer carbon nanotubes may be employed, including those in a range from about 5 to about 20 microns, including those in a range from about 20 microns to about 50 microns, including those in a range from about 50 microns to about 100 microns, including those in a range from about 100 microns to about 500 microns, including about 100, about 200, about 300, about 400, and about 500 microns.

In some embodiments, the carbon nanotubes can be employed with a diameter in a range from about 1 nm to about 500 nm. In some embodiments, the carbon nanotubes can have a diameter in a range from about 1 nm to about 10 nm, including about 1, about 2, about 3, about 4, about 5, about 6, about 7, about 8, about 9, and about 10 nm, including fractions thereof. In some embodiments, the carbon nanotubes can have a diameter in a range from about 10 nm to about 50 nm, including about 10, about 20, about 30, about 40 and about 50 nm, including all values in between and fractions thereof. In some embodiments, the carbon nanotubes can have a diameter in a range from about 50 nm to about 500 nm, including about 50, about 100, about 150, about 200, about 250, about 300, about 350, about 400, about 450, and about 500, including all values in between and fractions thereof.

In some embodiments, devices of the invention employ nanostructured materials comprising nanorods. As used herein, the term “nanorod” or “nanowire” refers to nanostructures that have a thickness or diameter from about 1 to about 50 nm and a length that is larger. For example, nanowires can have an aspect ratio is about 100 to about 1,000, or more. Nanorods can have aspect ratios are between about 10 to 100.

Exemplary nanorods or nanowires include, without limitation SiC, CdS, B₄C, ZnO, Ni, Pt, Si, InP, GaN, SiO₂, and TiO₂. SiC can be grown, for example, using nanoparticle catalysts based on chromium, nickel, iron, or combinations thereof using chemical vapor deposition (CVD) techniques with elemental carbon, silicon, and hydrogen. For exemplary procedures see U.S. Pat. No. 6,221,154. Gold nanoparticles, for example, can be used for the synthesis of CdS nanorods or nanowires. Molybdenum and iron based catalysts can be used in the preparation of a variety of carbide nanorod products including, for example, carbides of titanium, silicon, niobium, iron, boron, tungsten, molybdenum, zirconium, hafnium, vanadium, tantalum, chromium, manganese, technetium, rhenium, osmium, cobalt, nickel, a lanthanide series element, scandium, yttrium, lanthanum, zinc, aluminum, copper, germanium, and combinations thereof. Procedures for production of such carbides utilize thermal CVD techniques as described, for example, in U.S. Pat. No. 5,997,832. A number of transition metal catalyzed processes can be used for the production of zinc oxide nanorods or nanowires using thermal and plasma-enhanced CVD techniques.

In some embodiments, devices of the invention can employ other nanostructured materials, such as those selected from the group consisting of quantum dots, nano fibers, nanoflakes, nanoparticles, nanopillars, nanoplatelets, nanoshells, nanoflowers, nanocage, and nanomesh. The skilled artisan will recognize that the exact selection of a nanostructured material may be made based on its ability to generate an aerogel. In this regard, it is generally beneficial to select structures with high aspect ratios. In some embodiments, the aspect ratio may be in a range from about 10 to about 1,000. The aspect ratio can be larger, including about 10,000 or about 100,000. Aspect ratios under 10 may still be useful for the purpose of providing a large effective surface area, but may be less effective in forming an aerogel.

In some embodiments, devices of the invention employ thermoelectric materials comprising at least one selected from the group consisting of a bismuth chalcogenide, a lead chalcogenide, an inorganic clathrate, a silicide, a skutterudite, a metal oxide, and a conducting organic material. In some embodiments, the bisumuth chalcogenide can be Bi₂Te₃ or Bi₂Se₃. Bismuth telluride can be especially suitable for cooling the aerogel structure. In some embodiments, the lead chalcogenide can be lead telluride. The role of the thermoelectric material in pre-concentrator devices of the invention is to provide a cooling platform for the formation of the aerogel and for the operation of the pre-concentrator device in a detection system.

In some embodiments, devices of the invention employ thermoelectric materials as part of a Peltier device. In some such embodiments, the aerogel can be disposed on a cool side of the Peltier device. In some such embodiments, the aerogel can be disposed on a hot side of the Peltier device. The Peltier effect describes the isothermal heat exchange that takes place at the junction of two different materials when an electrical current flows between them. The rate of development of heat is greater or less than that of I²R heating, the difference depending upon the direction and magnitude of the electric current, on the temperature, and on the two materials forming the junction. In some embodiments, the Peltier device aids in the formation of the aerogel and is used in operation of the pre-concentrator in a detection system. In some embodiments, the Peltier device is configured to provide a surface with any of the aforementioned thermoelectric materials.

In some embodiments, the thermoelectric material is configured for cooling. In some embodiments the thermoelectric matieral is configured for heating. In some embodiments the thermoelectric material is configured for heating and cooling in cycles. The thermoelectric material can be arranged to be in thermal communication with the aerogel disposed thereon and may aid in cooling the aerogel structure to increase adsorption of the analyte to the surface of the aerogel. In some embodiments, sufficient adsorption may be realized without cooling and the thermoelectric material may be employed solely to provide heat to displace the adorbed analyte.

In some embodiments, the thermoelectric device may be configured to alter temperature as a function of time. In some such embodiments, change in temperature may be linear or non-linear. In some such embodiments, changes in temperature can be employed to effect release different analytes at different times from the aerogel. In some embodiments, changes in temperature can be employed to adsorb different analytes on the aerogel surface as a function of temperatures.

In some embodiments, the present invention provides a method of manufacturing a pre-concentrator device comprising an aerogel, the method comprising disposing a solution of a nanostructured material in a solvent on a surface of a thermoelectric material, cooling the solution of the nanostructured material with the aid of the thermoelectric material until the solvent freezes to provide an aerogel precursor, and subliming the aerogel precursor to provide the pre-concentrator device comprising the aerogel. In some embodiments, the present disclosure provides a method of forming the active element of a pre-concentrator device using carbon nanotubes (carbon nanotubes). Carbon nanotubes in the form of an aerogel have a high surface area which can provide a high level of adsorption. In addition, carbon nanotubes are thermally conductive, which allows them to be rapidly heated and cooled. Further, they can also be chemically modified so that they can be tailored towards highly selective sorption of particular molecular species, as described herein.

In some embodiments, methods for forming carbon nanotube aerogels can include the following operations. Although the following description is generally directed to forming a pre-concentrator, it should be recognized that carbon nanotube aerogels can be formed on any surface according to the described process, such aerogels may be used in numerous alternative applications. 1) A solution or suspension of carbon nanotube material is prepared. Its concentration, chemistry and composition with additives can all be adjusted to optimize the properties of the aerogel; in some embodiments, additives may include surfactants; in some embodiments, the solution is surfactant-free; 2) the target surface for the pre-concentrator film is identified and cooled. Non-limiting examples of suitable cooling methods include introduction of a coolant, contact with a cooled heat sink, or contact with a thermoelectric cooler; 3) a droplet or multiple droplets of the carbon nanotube solution or suspension is then deposited onto the cooled surface and allowed to freeze in place. The droplet(s) can be applied in a variety of ways including, for example, pipette, inkjet or spray system; and 4) with a cold surface temperature being maintained, the device can be placed into a vacuum and the frozen liquid from the solution or suspension is allowed to sublime. When sublimation is complete, the carbon nanotube aerogel film will be created and the device can be returned to ambient conditions. The same method can be employed with any of the nanostructured materials disclosed herein.

In some embodiments, the solution of nanostructured material employed to generate the aerogel can be water-based. In some embodiments, the solution of nanostructured material employed to generate the aerogel may be organic solvent-based. In some embodiments, mixed solvent systems can be employed. In some such embodiments, a surfactant can be present.

In some embodiments, the present invention provides a detection system comprising a pre-concentrator device, the pre-concentrator device comprising a thermoelectric material and an aerogel comprising a nanostructured material in thermal communication with the thermoelectric material, and a sensor; wherein the sensor is configured to receive one or more analytes from the pre-concentrator device. In some such embodiments, carbon nanotube aerogels can be used in a pre-concentrator device or other chemical sensor. Micro-sensors such as chemiresistors and FET sensors can benefit from the use of a pre-concentrator device to concentrate target analytes. Such devices can be configured to absorb incoming gases, vapor and chemicals over a relatively long time and then rapidly release the absorbed material toward a sensor(s), for example, via thermal desorption. The release of absorbed materials causes the sensor to receive a higher concentration of the species to be detected, thereby increasing the sensitivity and detection threshold of the sensor.

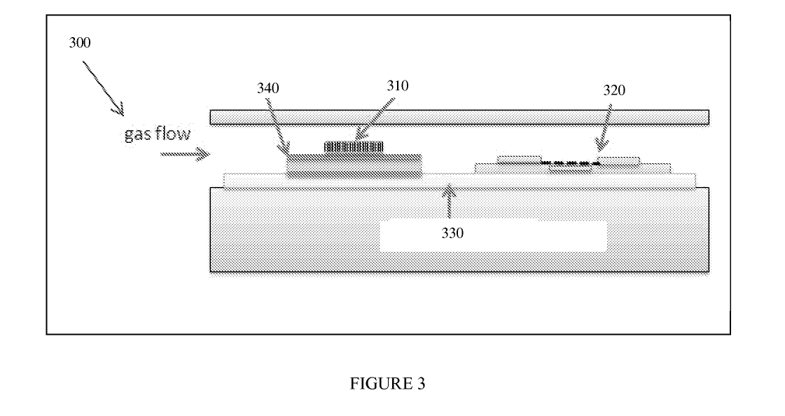

In some embodiments, systems of the invention employ nanostructured materials comprising carbon nanotubes. FIG. 3 shows a schematic of an illustrative carbon nanotube-based sensor system 300. System 300 comprises a carbon nanotubes-based pre-concentrator 310 and a sensor 320 located upon a platform 330. In some embodiments, pre-concentrator 310 and the sensor 320 contain carbon nanotubes in the same form. In other embodiments, they are different. In some embodiments, a heater/cooler device 340 comprising a thermoelectric material is in contact with the pre-concentrator. Heater/cooler device 340 can assist in adsorption or desorption of analyte molecules from pre-concentrator 310. In one embodiment, the heater/cooler device can be a NEXTREME heater/cooler.

Consistent with embodiments related to the pre-cocentrator device, in some embodiments, systems of the invention employ pre-concentrator devices comprising carbon nanotubes, the carbon nanotubes comprising at least one selected from the group consisting of single-walled carbon nanotubes (SWNTs), double-walled carbon nanotubes (DWNTs), and multi-walled carbon nanotubes (MWNTs). In some embodiments, systems of the invention employ carbon nanotubes that are functionalized. In some embodiments, systems of the invention employ nanostructured material comprising nanorods. In some embodiments, systems of the invention employ nanostructured material comprising a nanostructure selected from the group consisting of quantum dots, nanofibers, nanoflakes, nanoparticles, nanopillars, nanoplatelets, nanoshells, nanoflowers, nanocage, and nanomesh.

Likewise, in some embodiments, systems of the invention employ thermoelectric materials comprising at least one selected from the group consisting of a bismuth chalcogenide, a lead chalcogenide, an inorganic clathrate, a silicide, a skutterudite, a metal oxide, and a conducting organic material. In some embodiments, systems of the invention employ thermoelectric materials that are part of a Peltier device and the aerogel is disposed on a cool side of the Peltier device.

In some embodiments, systems of the invention employ sensors comprising at least one selected from the group consisting of an electrochemical sensor, a metal oxide semiconductor sensor; a chemiresistor sensor, a micro-cantilever sensor, a field effect transitor (FET) sensor, a microelectromechanical systems (MEMS)-based sensor, a surface acoustic waver (SAW) sensor, an optical sensor, a gas chromatograph sensor, an ion mobility spectroscopy/mass spectroscopy sensor.

The detection systems of the invention can include numerous FET-type sensors. Such sensors include, without limitation carbon nanotube field-effect transistor (CNTFET), DEPFET, a FET formed in a fully depleted substrate and acts as a sensor, amplifier and memory node at the same time, DGMOSFET, a MOSFET with dual gates, DNAFET, a specialized FET that acts as a biosensor, by using a gate made of single-strand DNA molecules to detect matching DNA strands, FREDFET (Fast Reverse or Fast Recovery Epitaxial Diode FET), a specialized FET designed to provide a very fast recovery (turn-off) of the body diode, HEMT (high electron mobility transistor), also called a HFET (heterostructure FET), made using bandgap engineering in a ternary semiconductor such as AlGaAs, HIGFET, a heterostructure insulated gate field effect transisitor, IGBT (insulated-gate bipolar transistor), a device for power control, ISFET (ion-sensitive field-effect transistor) used to measure ion concentrations in a solution, JFET (junction field-effect transistor) a reverse biased p-n junction to separate the gate from the body, MESFET (Metal-Semiconductor Field-Effect Transistor) which substitutes the p-n junction of the JFET with a Schottky barrier, MODFET (Modulation-Doped Field Effect Transistor) uses a quantum well structure formed by graded doping of the active region, MOSFET (Metal-Oxide-Semiconductor Field-Effect Transistor) which utilizes an insulator (typically SiO₂) between the gate and the body, NOMFET a Nanoparticle Organic Memory Field-Effect Transistor, OFET, an Organic Field-Effect Transistor using an organic semiconductor in its channel, GNRFET, a Field-Effect Transistor that uses a graphene nanoribbon for its channel, and VeSFET (Vertical-Slit Field-Effect Transistor), a square-shaped junction-less FET with a narrow slit connecting the source and drain at opposite corners.

In some embodiments, systems of the invention may comprise a carbon nanotube-based sensor platform comprising a pre-concentrator device and a sensor, where the pre-concentrator device and the sensor each contain carbon nanotubes. The form of the carbon nanotubes in the pre-concentrator device and the sensor can be the same or different. In some embodiments, the pre-concentrator device can contain a carbon nanotube aerogel.

In some embodiments, the present invention provides a method of detecting an analyte comprising: providing a detection system comprising: a pre-concentrator device, the pre-concentrator device comprising a thermoelectric material and an aerogel comprising a nanostructured material in thermal communication with the thermoelectric material; and a sensor; wherein the sensor is configured to receive the analyte from the pre-concentrator device; exposing a sample comprising the analyte in an eluant to the pre-concentrator device while cooling the pre-concentrator device to provide a bolus of concentrated analyte; and releasing the bolus of concentrated analyte for delivery to the sensor.

In some embodiments, the eluant is a gas, in some embodiments the eluant can be a liquid. When a liquid is employed as an eluant the analyte solution may be atomized, for example, with the aid of a nebulizer. In some embodiments, methods of the invention may employ the thermoelectric material to assist in adsorption of the analyte to the pre-concentrator device by providing cooling to the aerogel.

Referring back to FIG. 3, in operation gas flow carries an analyte over pre-concentrator 310, where an analyte of interest is adsorbed. Upon acquisition of sufficient analyte, the analyte of interest is desorbed from pre-concentrator 310, whereupon it is carried by the gas flow to sensor 320. Any type of sensor known in the art can be used in the present embodiments as described herein above.

To facilitate a better understanding of the present invention, the following examples of preferred embodiments are given. In no way should the following examples be read to limit, or to define, the scope of the invention.

### EXAMPLE

This example demonstrates the formation of a carbon nanotubes based aerogel, in accordance with embodiments of the invention.

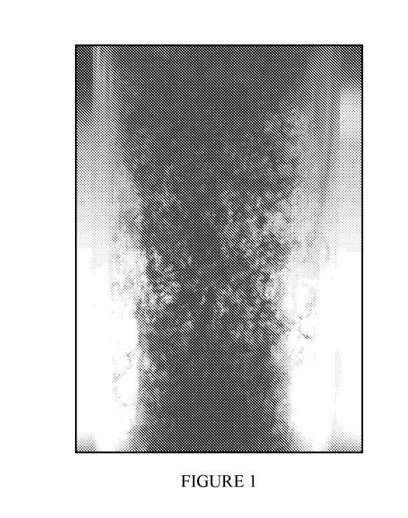

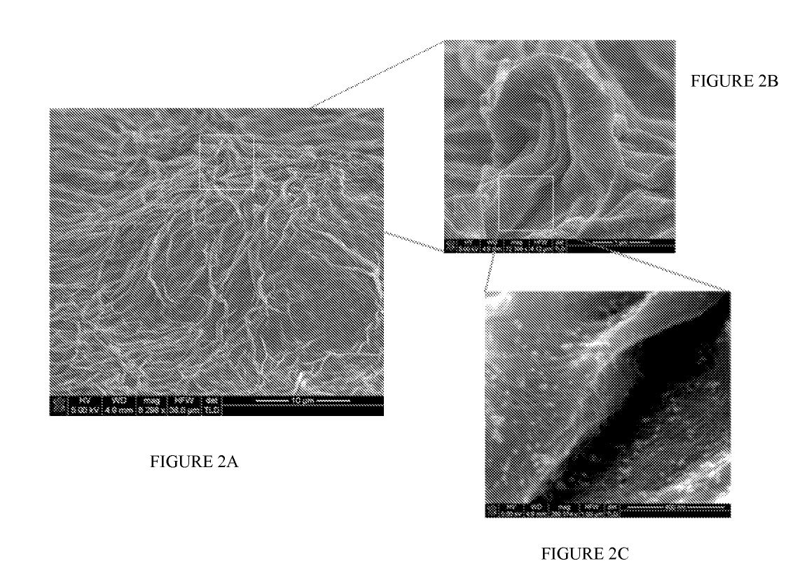

A carbon nanotube aerogel film was formed by depositing a carbon nanotube suspension from a pipette onto a cooled surface. This action formed pads of about 1 mm in diameter, although they could be made much smaller. The droplets froze essentially instantaneously, and the frozen solvent was then allowed to sublime to leave behind the aerogel. It should be noted that inkjet deposition can produce a complex patterning of the aerogel, if desired for the intended application. FIG. 1 shows an illustrative photograph of a carbon nanotube aerogel produced according to the methods described above. FIGS. 2A-2C show illustrative SEM images of a carbon nanotube aerogel formed by freeze drop deposition on a Si wafer surface according to the methods described above.

Although the invention has been described with reference to the disclosed embodiments, those skilled in the art will readily appreciate that these only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

The invention claimed is:

1. A pre-concentrator device comprising:
a thermoelectric material; and
an aerogel comprising a nanostructured material disposed on and in thermal communication with the thermoelectric material.

2. The device of claim 1, wherein the nanostructured material comprises carbon nanotubes.

3. The device of claim 2, wherein the carbon nanotubes comprise at least one selected from the group consisting of single-walled carbon nanotubes (SWNTs), double-walled carbon nanotubes (DWNTs), and multi-walled carbon nanotubes (MWNTs).

4. The device of claim 2, wherein the carbon nanotubes are functionalized.

5. The device of claim 1, wherein the nanostructured material comprises nanorods.

6. The device of claim 1, wherein the nanostructured material comprises a nanostructure selected from the group consisting of quantum dots, nanofibers, nanoflakes, nanoparticles, nanopillars, nanoplatelets, nanoshells, nano flowers, nanocage, and nanomesh.

7. The device of claim 1, wherein the thermoelectric material comprises at least one selected from the group consisting of a bismuth chalcogenide, a lead chalcogenide, an inorganic clathrate, a silicide, a skutterudite, a metal oxide, and a conducting organic material.

8. The device of claim 1, wherein the thermoelectric material is part of a Peltier device.

9. The device of claim 8, wherein the aerogel is disposed on a cool side of the Peltier device.

10. A method of manufacturing a pre-concentrator device comprising an aerogel, the method comprising:
disposing a solution of a nanostructured material in a solvent on a surface of a thermoelectric material;
cooling the solution of the nanostructured material with the aid of the thermoelectric material until the solvent freezes to provide an aerogel precursor; and
subliming the aerogel precursor to provide the pre-concentrator device comprising the aerogel.

11. A detection system comprising:
a pre-concentrator device, the pre-concentrator device comprising a thermoelectric material and an aerogel comprising a nanostructured material in thermal communication with the thermoelectric material; and
a sensor;
wherein the sensor is configured to receive one or more analytes from the pre-concentrator device.

12. The system of claim 11, wherein the nanostructured material comprises carbon nanotubes.

13. The system of claim 12, wherein the carbon nanotubes comprise at least one selected from the group consisting of single-walled carbon nanotubes (SWNTs), double-walled carbon nanotubes (DWNTs), and multi-walled carbon nanotubes (MWNTs).

14. The system of claim 12, wherein the carbon nanotubes are functionalized.

15. The system of claim 11, wherein the nanostructured material comprises nanorods.

16. The system of claim 11, wherein the nanostructured material comprises a nanostructure selected from the group consisting of quantum dots, nanofibers, nanoflakes, nanoparticles, nanopillars, nanoplatelets, nanoshells, nano flowers, nanocage, and nanomesh.

17. The system of claim 11, wherein the thermoelectric material comprises at least one selected from the group consisting of a bismuth chalcogenide, a lead chalcogenide, an inorganic clathrate, a silicide, a skutterudite, a metal oxide, and a conducting organic material.

18. The system of claim 11, wherein the thermoelectric material is part of a Peltier device and the aerogel is disposed on a cool side of the Peltier device.

19. The system of claim 11, wherein the sensor comprises at least one selected from the group consisting of an electrochemical sensor, a metal oxide semiconductor sensor; a chemiresistor sensor, a micro-cantilever sensor, a field effect transitor (FET) sensor, a microelectromechanical systems (MEMS)-based sensor, a surface acoustic waver (SAW) sensor, an optical sensor, a gas chromatograph sensor, an ion mobility spectroscopy/mass spectroscopy sensor.

20. A method of detecting an analyte comprising:
providing a detection system comprising:
a pre-concentrator device, the pre-concentrator device comprising a thermoelectric material and an aerogel comprising a nanostructured material in thermal communication with the thermoelectric material; and
a sensor;
wherein the sensor is configured to receive the analyte from the pre-concentrator device;
exposing a sample comprising the analyte in an eluant to the pre-concentrator device while cooling the pre-concentrator device to provide a bolus of concentrated analyte; and
releasing the bolus of concentrated analyte for delivery to the sensor.
